(19) United States
(12) Patent Application Publication
(10) Pub. No.: US 2025/0202647 A1
(43) Pub. Date: Jun. 19, 2025

(54) APPLICATION OF SEQUENCE-BASED FREQUENCY SHAPING TO MULTIPLEXED UPLINK DATA STREAMS

(71) Applicant: Lenovo (United States) Inc., Morrisville, NC (US)

(72) Inventors: Ali Ramadan ALI, Kraiburg am Inn (DE); Karthikeyan GANESAN, Nauheim (DE)

(21) Appl. No.: 19/067,226

(22) Filed: Feb. 28, 2025

(51) Int. Cl. H04L 5/00; H04L 27/26

(52) U.S. Cl. CPC H04L 5/0048; H04L 27/2614

(57) ABSTRACT

Various aspects of the present disclosure relate to multiplexing data streams in uplink while maintaining a low peak to average power ratio (PAPR). A base station may configure and/or cause a user equipment (UE) to apply sequence-based frequency shaping to multiplexed data streams. For example, the base station may configure a UE to select, from a set of potential or candidate sequences, a sequence that, when applied to generated data streams (e.g., frequency domain data streams), realizes a low (or lowest) PAPR or other similar metric (e.g., a cubic metric, or CM), such as for generated time domain data streams.

### TECHNICAL FIELD

The present disclosure relates to wireless communications, and more specifically to applying sequence-based frequency shaping to multiplexed uplink (UL) data streams.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support the application of sequence-based frequency shaping to multiplexed uplink (UL) data streams, such as discrete Fourier transform spread orthogonal frequency division multiplexed (DFT-s-OFDM) data streams.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit a configuration comprising a set of sequences, wherein each sequence of the set of sequences is applicable to multiple data streams on a frequency domain, receive an indication of one or more selected sequences from the set of sequences; and receive non-orthogonally multiplexed data streams shaped via the selected sequences.

A method performed or performable by the network entity is described. The method may comprise transmitting a configuration comprising a set of sequences, wherein each sequence of the set of sequences is applicable to multiple data streams on a frequency domain in a UL channel, receiving an indication of one or more selected sequences from the set of sequences, and receiving non-orthogonally multiplexed data streams shaped via the selected sequences.

In some implementations of the network entity and method described herein, the network entity and method may further be configured to, capable of, performed, performable, or operable to transmit the configuration via a radio resource control (RRC) message.

In some implementations of the network entity and method described herein, the network entity and method may further be configured to, capable of, performed, performable, or operable to transmit the configuration in a system information block type 1 (SIB1).

In some implementations of the network entity and method described herein, the configuration indicates to apply a same sequence of the set of sequences to each data stream on the frequency domain.

In some implementations of the network entity and method described herein, the configuration indicates to apply a different sequence of the set of sequences to each data stream on the frequency domain.

In some implementations of the network entity and method described herein, the configuration includes an identifier of a sequence of the set of sequences, and wherein the identifier corresponds to a row index of a table that maps each sequence of the set of sequences to each data stream of the multiple data streams.

A UE for wireless communication is described. The UE may be configured to, capable of, or operable to perform one or more operations as described herein. For example, the UE may comprise at least one memory and at least one processor coupled with the at least one memory and configured to cause the UE to receive a configuration comprising a set of sequences, wherein each sequence of the set of sequences is applicable to multiple data streams on a frequency domain, select one or more sequences of the set of sequences, and transmit, an indication of the selected one or more sequences from the set of sequences.

A processor for wireless communication is described. The processor may be configured to, capable of, or operable to perform one or more operations as described herein. For example, the UE may comprise at least one controller and at least one memory coupled with the at least one controller and configured to cause the processor to receive a configuration comprising a set of sequences, wherein each sequence of the set of sequences is applicable to multiple data streams on a frequency domain, select one or more sequences of the set of sequences, and transmit an indication of the selected one or more sequences from the set of sequences.

A method performed or performable by the UE is described. The method may comprise receiving a configuration comprising a set of sequences, wherein each sequence of the set of sequences is applicable to multiple data streams on a frequency domain, selecting one or more sequences of the set of sequences, and transmitting an indication of the selected one or more sequences from the set of sequences.

In some implementations of the UE, processor, and method described herein, the UE, processor, and method may further be configured to, capable of, performed, performable, or operable to transmit non-orthogonally multiplexed data streams shaped via the one or more selected sequences.

In some implementations of the UE, processor, and method described herein, the configuration comprises an indication to apply modified Hamming shaping to the non-orthogonally multiplexed data streams on the frequency domain.

In some implementations of the UE, processor, and method described herein, the modified Hamming shaping comprises a square of a Hamming window.

In some implementations of the UE, processor, and method described herein, the modified Hamming shaping comprises a square root of a Hamming window.

In some implementations of the UE, processor, and method described herein, the non-orthogonally multiplexed data streams comprise data streams multiplexed with a control channel.

In some implementations of the UE, processor, and method described herein, the UE, processor, and method may further be configured to, capable of, performed, performable, or operable to generate non-orthogonally multiplexed data streams by applying the selected one or more sequences to the multiple data streams in an iterative manner.

In some implementations of the UE, processor, and method described herein, the UE, processor, and method may further be configured to, capable of, performed, performable, or operable to determine a value of a peak to average power ratio (PAPR) for each sequence of the selected one or more sequences and select a sequence associated with a lowest PAPR value.

In some implementations of the UE, processor, and method described herein, the UE, processor, and method may further be configured to, capable of, performed, performable, or operable to receive the configuration via an RRC message.

In some implementations of the UE, processor, and method described herein, the UE, processor, and method may further be configured to, capable of, performed, performable, or operable to receive the configuration in a SIB1.

### BRIEF DESCRIPTION OF THE DRAWINGS

FIG. 1 illustrates an example of a wireless communications system in accordance with aspects of the present disclosure.

FIG. 2 illustrate an example sequence-based application in accordance with aspects of the present disclosure.

FIGS. 3A-3C illustrate example applications of frequency domain windowing in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by an NE in accordance with aspects of the present disclosure.

FIG. 8 illustrates a flowchart of a method performed by a UE in accordance with aspects of the present disclosure.

### DETAILED DESCRIPTION

A wireless communications system may support cyclic prefix OFDM (CP-OFDM)-based waveforms for both UL and downlink (DL) and DFT-s-OFDM waveforms for UL. Based on coverage and/or power consumptions requirements, an UL waveform may be dynamically switched between CP-OFDM and DFT-s-OFDM. However, certain issues, such as reduced throughput, may arise when utilizing DFT-s-OFDM waveforms.

Some radio access technologies, such as 5G, may support use of a single multiple-input-multiple-output (MIMO) layer for DFT-s-OFDM, because the use of additional MIMO layers would increase an associated peak to average power ratio (PAPR) for transmitting antenna panels to undesirable values (e.g., the peak power would undesirably increase). While certain multiplexing techniques, such as non-orthogonal multiple access (NOMA), may assist in scaling data streams from single or multiple antenna panels, the techniques may also introduce interference at the antenna panels and/or increase the PAPR.

Various aspects of the present disclosure relate to multiplexing data streams in while maintaining a low PAPR. A base station may configure and/or cause a UE to apply sequence-based frequency shaping to multiplexed data streams, such as DFT-s-OFDM data streams. For example, the base station may configure a UE to select, from a set of candidate sequences, a sequence (e.g., a phase sequence with defined phase shifts). When applied to generated data streams (e.g., frequency domain data streams), the UE selects the sequence that yields a low (or lowest) PAPR or other similar metric (e.g., a cubic metric (CM)), such as for generated time domain data streams. In doing so, the base station and/or the UE may utilize multiplexed (e.g., DFT-s-OFDM) data streams over channels (e.g., UL channels) while maintaining or reducing an associated PAPR, among other benefits.

Aspects of the present disclosure are described in the context of a wireless communications system.

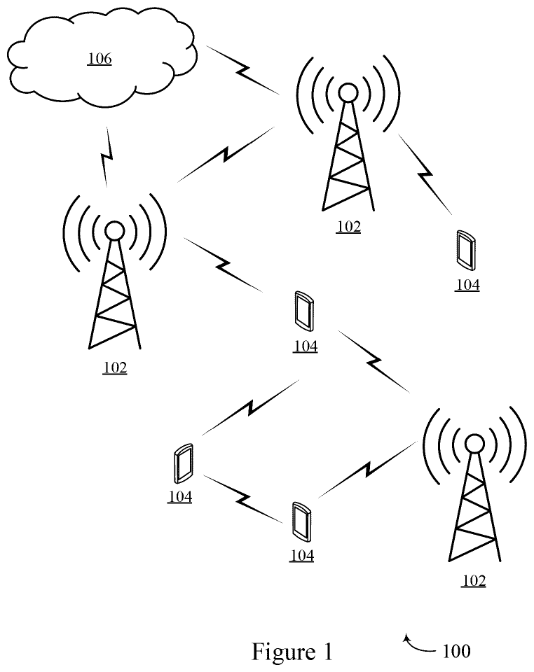

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, either slots per subrame, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may perform, support, and/or utilize sequence-based frequency shaping to multiplexed UL data streams, such as DFT-s-OFDM data streams. A NE 102 (e.g., a base station) may configure a UE 104 with a set of sequences that the UE may apply to generated frequency domain data, such that generated time domain data, associated with the generated frequency domain data, has a low (e.g., minimum) PAPR and/or CM.

A sequence may be a phase sequence that adjusts (e.g., changes, modifies, updates) the phase of complex data (e.g., generated frequency domain data). Each sequence may be generated with random phase shifts (e.g., for each sample). The generated sequences, when applied to (e.g., multiplied with) complex data, shape or otherwise adjust the phase of the data, which can cause a change in the PAPR and/or CM when the data is converted (e.g., transformed) from the frequency domain to the time domain. For example, the NE 102 may transmit, as part of system information (SI) (e.g., a SIB1) or RRC signaling (e.g., an RRC message), a configuration comprising a set of sequences that are applicable to multiple data streams on the frequency domain for an UL channel.

In some examples, the set of sequences may be defined in a table or another data structure, where each sequence is assigned a predefined index. The NE 102 may transmit a corresponding row index of the table to the UE 104, allowing the UE 104 to identify the associated sequence based on the corresponding row index. The UE 104, based on a number of data streams to be configured, selects a number of sequences, from the set of sequences, to be applied to generated frequency domain data streams. In some embodiments, the UE applies the set of sequences in an iterative manner. For example, the UE 104 may iteratively apply the set of sequences, processing (e.g., generating, applying, modifying, outputting, transmitting) each sequence consecutively (e.g., in succession) to select a suitable or optimal sequence from the set of sequences.

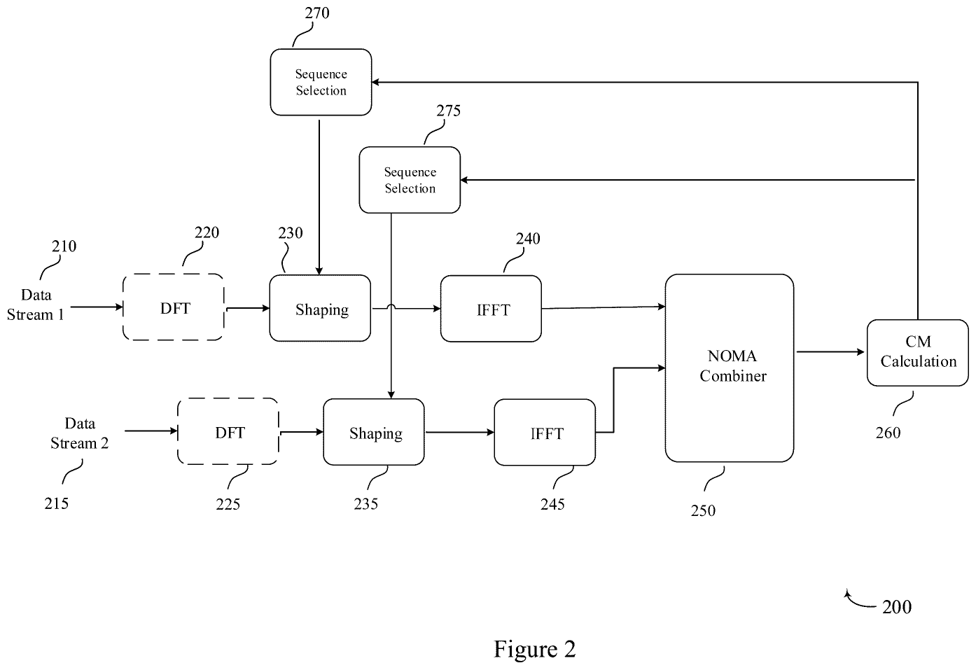

FIG. 2 illustrate an example sequence-based application 200 in accordance with aspects of the present disclosure. In some examples, the sequence-based application 200 may implement aspects of the wireless communications system 100. For example, the sequence-based application 200 may be implemented by a NE 102 and/or a UE 104, which may be examples of a NE 102 and a UE 104 as described with reference to FIG. 1. As such, one or more elements described herein may be performed at the NE 102 and/or the UE 104. Additionally, examples of the following may be implemented, where some processes (e.g., operations, signaling, and the like) are performed in a different order than described or are not performed. In some cases, processes (e.g., operations, signaling, and the like) may include additional features not mentioned below, or further processes (e.g., operations, signaling, and the like) may be added.

The UE 104 transforms a first data stream 210 (e.g., from the time domain to the frequency domain) via a Discrete Fourier Transform (DFT) 220, and then applies, via a shaping module 230, one or more sequences to shape the transformed data stream, as described herein. Similarly, The UE 104 transforms a second data stream 215 via a DFT 225 and shapes the data stream 215 via a shaping module 235. The UE 104 transforms shaped data streams (e.g., back to the time domain) via Inverse Fast Fourier Transforms (IFFTs) 240, 245, and input to a NOMA combiner 250.

The UE 104, via a NOMA combiner 250, generates a combined data stream (e.g., a combined time domain signal based on NOMA or other spatial multiplexing), which is input to a CM calculation module 260. The UE 104, via a CM calculation module 260, calculates a PAPR or other CM (e.g., a CM value from 0 to 5 dB), where a low value (e.g., 0 or 1 dB) indicates efficiency at a power amplifier associated with an antenna panel (e.g., of the UE 104). The UE 104 may then output the CM or PAPR value to sequence selection modules 270, 275 associated with the data streams 210, 215. After iterations for each sequence of a set of sequences (e.g., 16 iterations for 16 candidate sequences), the UE 104 selects the sequence that, when applied to the data streams 210, 215, realizes a lowest CM (e.g., a lowest PAPR).

In some cases, the UE 104 may apply a same sequence to each data stream (e.g., the data streams 210, 215) of multiple data streams. In other cases, the UE 104 may apply different sequences to different data streams (e.g., a first sequence to the data stream 210, and a second sequence to the data stream 215). In some examples, the UE 104 may receive a configuration, which may indicate the sequences to be applied and/or the UE 104 may determine what sequences to apply to the different data streams. The UE 104 may select to apply a same sequence to all data streams and/or different sequences to each data stream based on one or more capabilities of the UE 104. For example, the UE 104 may introduce additional complexities, in terms of the number of iterations of applying and measuring the CM of different sequences for each data streams, when selecting sequences to apply to the data streams (e.g., effectively or efficiently).

The UE 104 may transmit one or more indexes back to the NE 102 for each selected sequence (corresponding to each multiplexed data stream). For example, the UE 104 may transmit an indication of a selected sequence via a control channel (e.g., uplink control information (UCI) via a physical uplink control channel (PUCCH)). The NE 102, using the selected sequence, may recover or retrieve the original UL data (e.g., the UL data before shaping).

In some embodiments, the UE 104 may be configured to non-orthogonally multiplex (e.g., NOMA) the data with a control channel, such as a physical uplink control channel (PUCCH). For example, the UE 104 may transmit the data as one data stream (e.g., physical uplink shared channel (PUSCH)) that is multiplexed (e.g., using NOMA) with a control channel (e.g., PUCCH) as another stream. Similar to the iterative procedure of FIG. 2, the UE 104 may apply multiple sequences on the frequency domain for the control channel and the data channel before combining the data streams, and then select a combined stream associated with a lowest PAPR or CM.

In some embodiments, the UE 104 may apply frequency domain windowing on frequency domain data. For example, based on the configuration from the NE 102, the UE 104 may utilize frequency domain windowing to realize a minimum PAPR or CM for a generated time domain signal or data stream. The UE 104 may support various window functions. In some cases, a window type (also referred to as a type of window function) may be selected or otherwise based on a configured waveform (e.g., CP-OFDM and/or DFT-s-OFDM), a number of streams to be multiplexed, and/or a modulation order. For example, a window type may be a Hamming window. A Hamming window function may be used for pulse shaping. Additionally, the Hamming window may reduce the PAPR of a generated signal when multiple streams are multiplexed together.

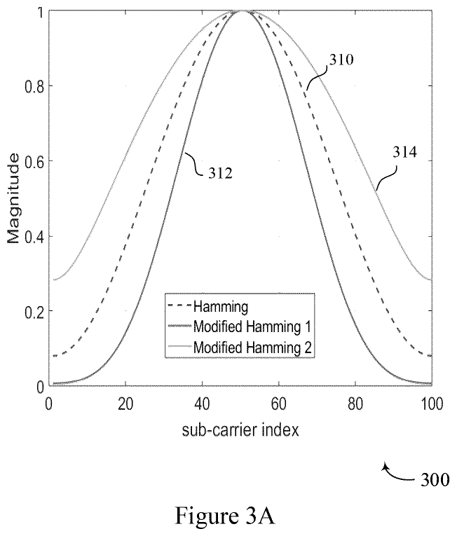

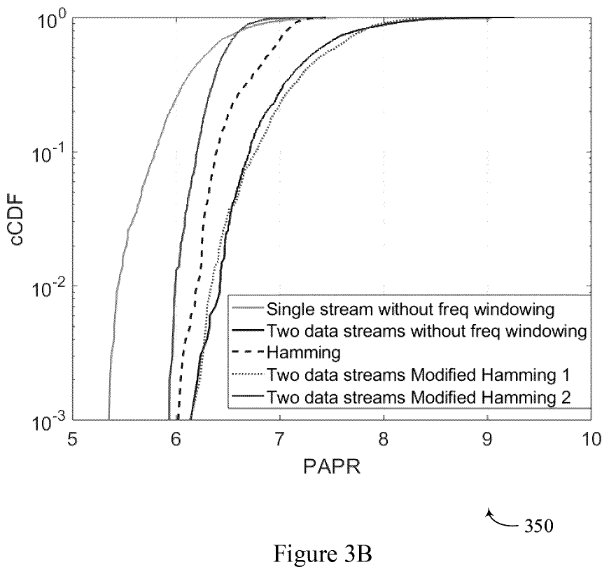

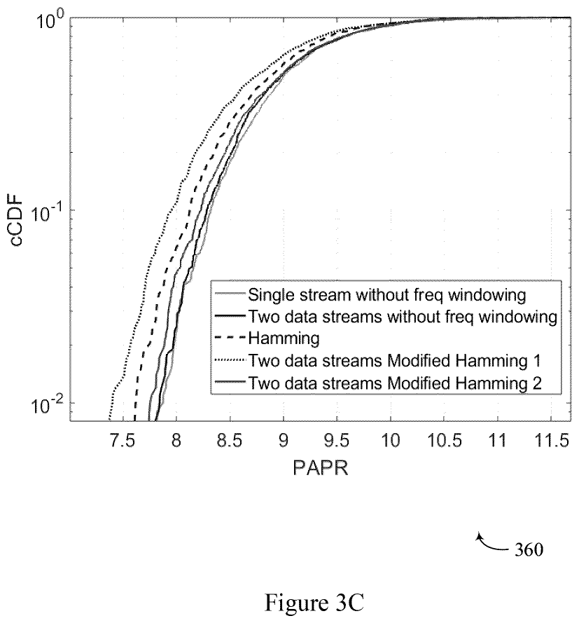

Other examples of types of window functions includes, but is not limited to, a Hanning window, a Kaiser window, a Blackman window, flat top window, and the like. In some other cases, the UE 104 may modify a Hamming window based on the configured waveform. For example, a modified Hamming window may be a square of a legacy Hamming window and/or a square root of a legacy Hamming window. FIGS. 3A-3C illustrate example applications of frequency domain windowing in accordance with aspects of the present disclosure.

FIG. 3A is a graph 300 presenting the application of different frequency domain Hamming windows, The graph depicts the amplitude of the window, with respect to various sub-carrier indexes, and includes a legacy Hamming window 310, a square of the Hamming window 310 (e.g., a modified hamming window 312), and a square root of the Hamming window 310 (e.g., a modified hamming window 314).

FIGS. 3B-3C represent performance enhancements in terms of PAPR when applying a modified Hamming window for shaping the frequency of non-orthogonally multiplexed UL data streams. FIG. 3B presents a graph 350 of the PAPR of DFT-s-OFDM for two multiplexed data streams (with quadrature phase shift keying (QPSK) modulation). As shown, a square root of the Hamming window (e.g., the modified hamming window 314) is optimal for DFT-s-OFDM data streams. FIG. 3C presents a graph 360 of the PAPR of CP-OFDM for two multiplexed data streams (with quadrature phase shift keying (QPSK) modulation). As shown, a square of the Hamming window (e.g., the modified hamming window 312) is optimal for DFT-s-OFDM data streams.

Thus, in various embodiments, the systems and methods described herein may reduce PAPR by employing sequence-based frequency shaping for multiplexed UL data streams. Further, in some cases, a UE may utilize frequency domain windowing to reduce the PAPR and/or CM for both CP-OFDM and DFT-s-OFDM data streams, among other benefits.

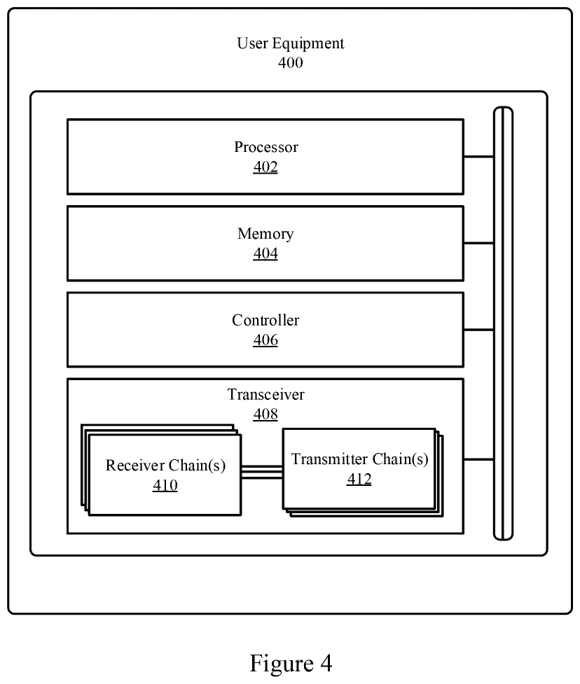

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for receiving a configuration comprising a set of sequences, wherein each sequence of the set of sequences is applicable to multiple data streams on a frequency domain, selecting one or more sequences of the set of sequences; and transmitting an indication of the selected one or more sequences from the set of sequences.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

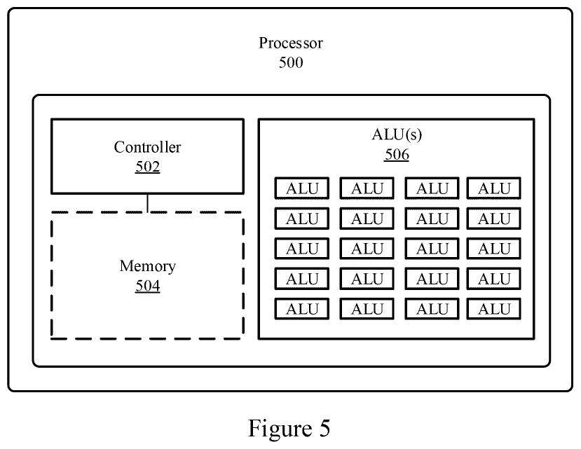

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. For example, the processor 500 may be configured to support a means for receiving a configuration comprising a set of sequences, wherein each sequence of the set of sequences is applicable to multiple data streams on a frequency domain, selecting one or more sequences of the set of sequences; and transmitting an indication of the selected one or more sequences from the set of sequences.

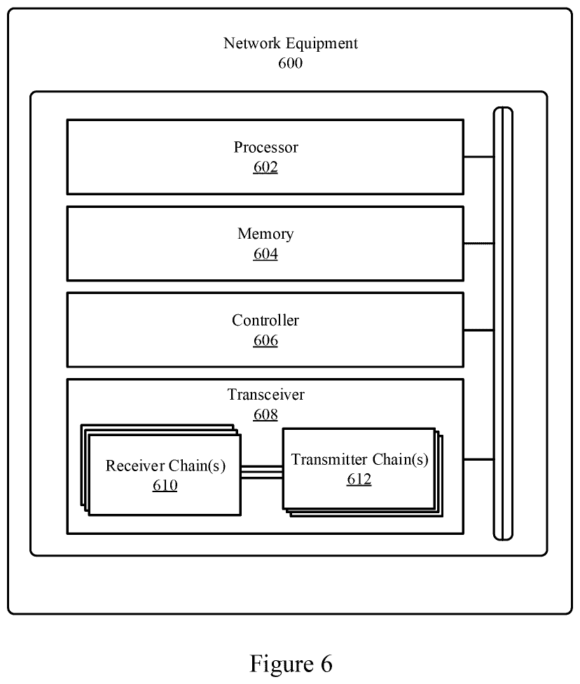

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for transmitting a configuration comprising a set of sequences, wherein each sequence of the set of sequences is applicable to multiple data streams on a frequency domain; receiving an indication of one or more selected sequences from the set of sequences; and receiving non-orthogonally multiplexed data streams shaped via the selected sequences.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

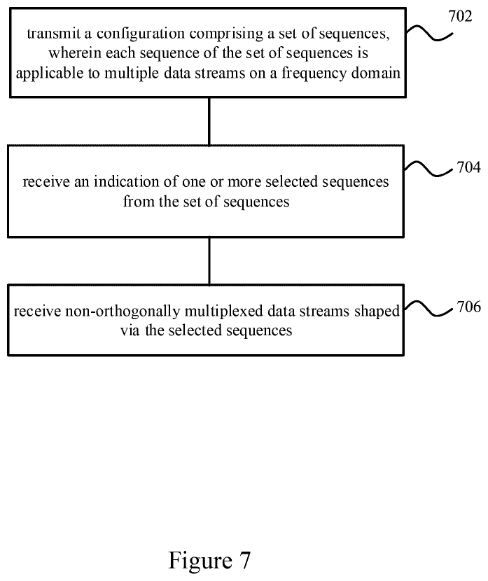

FIG. 7 illustrates a flowchart of a method in accordance with aspects of the present disclosure. The operations of the method may be implemented by an NE as described herein. In some implementations, the NE may execute a set of instructions to control the function elements of the NE to perform the described functions.

At 702, the method may include transmitting a configuration comprising a set of sequences, wherein each sequence of the set of sequences is applicable to multiple data streams on a frequency domain. The operations of 702 may be performed in accordance with examples as described herein. In some implementations, aspects of the operations of 702 may be performed by an NE described with reference to FIG. 6.

At 704, the method may include receiving an indication of one or more selected sequences from the set of sequences. The operations of 704 may be performed in accordance with examples as described herein. In some implementations, aspects of the operations of 704 may be performed by an NE as described with reference to FIG. 6.

At 706, the method may include receiving non-orthogonally multiplexed data streams shaped via the selected sequences. The operations of 706 may be performed in accordance with examples as described herein. In some implementations, aspects of the operations of 706 may be performed by an NE as described with reference to FIG. 6.

It should be noted that the method described herein describes a possible implementation, and that the operations and the steps may be rearranged or otherwise modified and that other implementations are possible.

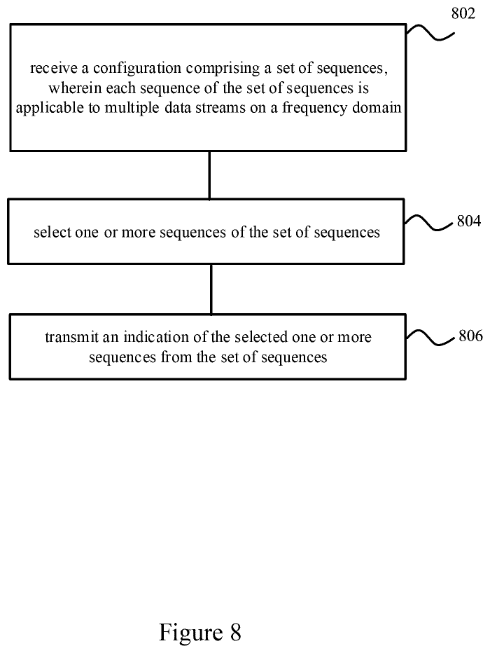

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving a configuration comprising a set of sequences, wherein each sequence of the set of sequences is applicable to multiple data streams on a frequency domain. The operations of 802 may be performed in accordance with examples as described herein. In some implementations, aspects of the operations of 802 may be performed by a UE as described with reference to FIG. 4.

At 804, the method may include selecting one or more sequences of the set of sequences. The operations of 804 may be performed in accordance with examples as described herein. In some implementations, aspects of the operations of 804 may be performed by a UE as described with reference to FIG. 4.

At 806, the method may include transmitting an indication of the selected one or more sequences from the set of sequences. The operations of 806 may be performed in accordance with examples as described herein. In some implementations, aspects of the operations of 806 may be performed by a UE as described with reference to FIG. 4.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
transmit a configuration comprising a set of sequences, wherein each sequence of the set of sequences is applicable to multiple data streams on a frequency domain;
receive an indication of one or more selected sequences from the set of sequences; and
receive non-orthogonally multiplexed data streams shaped via the selected sequences.

2. The network entity of claim 1, wherein the at least one processor is configured to cause the network entity to transmit the configuration via a radio resource control (RRC) message.

3. The network entity of claim 1, wherein the at least one processor is configured to cause the network entity to transmit the configuration in a system information block type 1 (SIB1).

4. The network entity of claim 1, wherein the configuration indicates to apply a same sequence of the set of sequences to each data stream on the frequency domain.

5. The network entity of claim 1, wherein the configuration indicates to apply a different sequence of the set of sequences to each data stream on the frequency domain.

6. The network entity of claim 1, wherein the configuration includes an identifier of a sequence of the set of sequences, and wherein the identifier corresponds to a row index of a table that maps each sequence of the set of sequences to each data stream of the multiple data streams.

7. A user equipment (UE) for wireless communication, comprising:
at least one memory; and
at least one processor coupled with the at least one memory and configured to cause the UE to:
receive a configuration comprising a set of sequences, wherein each sequence of the set of sequences is applicable to multiple data streams on a frequency domain;
select one or more sequences of the set of sequences; and
transmit an indication of the selected one or more sequences from the set of sequences.

8. The UE of claim 7, wherein the at least one processor is further configured to cause the UE to:
transmit non-orthogonally multiplexed data streams shaped via the one or more selected sequences.

9. The UE of claim 8, wherein the configuration indicates to apply modified Hamming shaping to the non-orthogonally multiplexed data streams on the frequency domain.

10. The UE of claim 9, wherein the modified Hamming shaping comprises a square of a Hamming window.

11. The UE of claim 9, wherein the modified Hamming shaping comprises a square root of a Hamming window.

12. The UE of claim 8, wherein the non-orthogonally multiplexed data streams comprise data streams multiplexed with a control channel.

13. The UE of claim 7, wherein the at least one processor is further configured to cause the UE to generate non-orthogonally multiplexed data streams by applying the selected one or more sequences to the multiple data streams in an iterative manner.

14. The UE of claim 13, wherein the at least one processor is further configured to cause the UE to:
determine a value of a peak to average power ratio (PAPR) for each sequence of the selected one or more sequences; and
select a sequence associated with a lowest PAPR value.

15. The UE of claim 7, wherein the at least one processor is configured to cause the UE to receive the configuration via a radio resource control (RRC) message.

16. The UE of claim 7, wherein the at least one processor is configured to cause the UE to receive the configuration in a system information block type 1 (SIB1).

17. A method performed by a network entity, the method comprising:
Transmitting a configuration comprising a set of sequences,
wherein each sequence of the set of sequences is applicable to multiple data streams on a frequency domain;
receiving an indication of one or more selected sequences from the set of sequences; and
receiving non-orthogonally multiplexed data streams shaped via the selected sequences.

18. A method performed by a user equipment (UE), the method comprising:
receiving a configuration comprising a set of sequences,
wherein each sequence of the set of sequences is applicable to multiple data streams on a frequency domain;
selecting one or more sequences of the set of sequences; and
transmitting an indication of the selected one or more sequences from the set of sequences.

19. The method of claim 18, further comprising:
Transmitting non-orthogonally multiplexed data streams shaped via the one or more selected sequences.

20. The method of claim 18, further comprising:
determining a value of a peak to average power ratio (PAPR) for each sequence of the selected one or more sequences; and
selecting a sequence associated with a lowest PAPR value.
